(19) United States
(12) Patent Application Publication
(10) Pub. No.: US 2020/0391361 A1
(43) Pub. Date: Dec. 17, 2020

(54) HOSE REMOVER

(71) Applicant: SHUHUI QIAN, NINGBO CITY (CN)

(72) Inventor: SHUHUI QIAN, NINGBO CITY (CN)

(21) Appl. No.: 16/443,800

(22) Filed: Jun. 17, 2019

(51) Int. Cl. B25B 27/10; B25B 27/14

(52) U.S. Cl. CPC B25B 27/10; B25B 27/146

(57) ABSTRACT

A hose remover includes an arcuate flexible section with flexibilities on both opposite sides of the arcuate flexible section and capable of tying close to or being away from each other and restoring their original positions; a first extending portion, formed and extending from a side of the arcuate flexible section; a second extending portion, formed and extending from the other side of the arcuate flexible section which is different from the side of the first extending portion; two hose clamping portions, formed at ends of the first and second extending portions respectively, such that the arcuate flexible section, the first extending portion, the second extending portion and the hose clamping portion are in an integral structure mode.

### FIELD OF INVENTION

The present invention relates to a hose remover, in particular to the hose remover with a structure capable of lowering the manufacturing and assembling costs and improving the convenience of use.

### BACKGROUND OF INVENTION

### 1. Description of the Related Art

In general, most conventional cooling hose removers for motor vehicles are formed by a multiple of components and used for clamping the external periphery of the expanded cooling hose to remove the hose, and these components include left and right clamping members and a mandrel installed at the bottom of each clamping member, and a rubber band is tied to the middle of the left and right clamping members or a spring component is installed to provide the elastic force for the left and right clamping members. However, this conventional structure has been used for years to provide the basic removal function, and such structure involves too many components and thus has the drawbacks of high manufacturing cost, difficult assembling, and short service life. Therefore, the conventional cooling hose remover is designed with a single-piece structure to overcome the aforementioned problems. The clamping member of the conventional structure just comes with one size and the expansion cannot be achieved according to different external peripheries of different cooling hoses, and it is necessary to manufacture the cooling hose removers of different sizes according to the external periphery of the cooling hose to meet the removal on requirements, and the conventional structure does not provide the all-in-one function and has the drawbacks of inconvenient carry and use.

### 2. Summary of the Invention

Therefore, it is a primary objective of the present invention to provide an integral structure of a hose remover capable of reducing the manufacturing and assembling costs effectively and adjusting the opening and closing of the hose clamping portions to improve the convenience of use.

To achieve the aforementioned and other objectives, the present invention provides a hose remover comprising: an arcuate flexible section, having a flexibility on both opposite sides of the arcuate flexible section separately, and both flexibilities capable of tying close to each other or being away from each other and restoring original position; a first extending portion, formed and extending from a side of the arcuate flexible section; a second extending portion, formed and extending from the other side of the arcuate flexible section which is different from the side of the first extending portion; two hose clamping portions, formed at ends of the first and second extending portions respectively, such that the arcuate flexible section, the first extending portion, the second extending portion and the hose clamping portion are in an integral structure mode; wherein, the first and second extending portions extend towards different directions to form an up and down intersecting form, and the hose clamping portions normally lean against each other, and the arcuate flexible section is pressed to spread the hose clamping portions away from one another or to lean the hose clamping portions against one another.

The present invention will become clearer in light of the following detailed description of an illustrative embodiment of this invention described in connection with the drawings, so that people having ordinary skill in the art can implement the present invention according to the description of this specification.

### BRIEF DESCRIPTION OF THE DRAWINGS

FIG. 1 is a perspective view of the present invention;

FIG. 2 is a side view of the present invention;

FIG. 3 is a schematic view of an operating status of the present invention; and

FIG. 4 is a schematic view of an operating status of the present invention.

### DESCRIPTION OF THE PREFERRED EMBODIMENTS

To make it easier for our examiner to understand the objective of the invention, its structure, innovative features, and performance, we use a preferred embodiment together with the attached drawings for the detailed description of the invention.

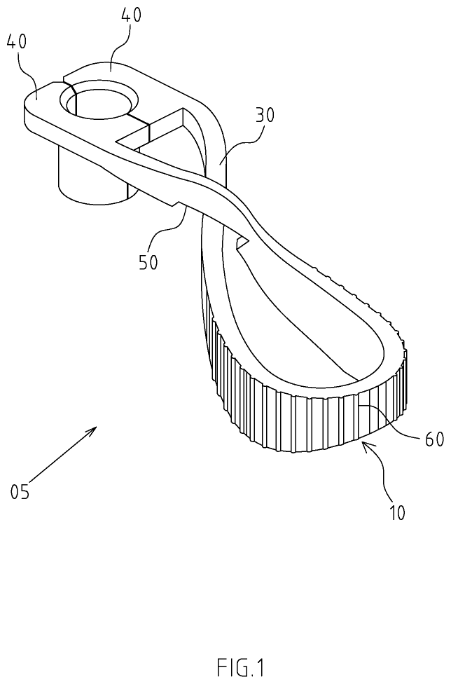

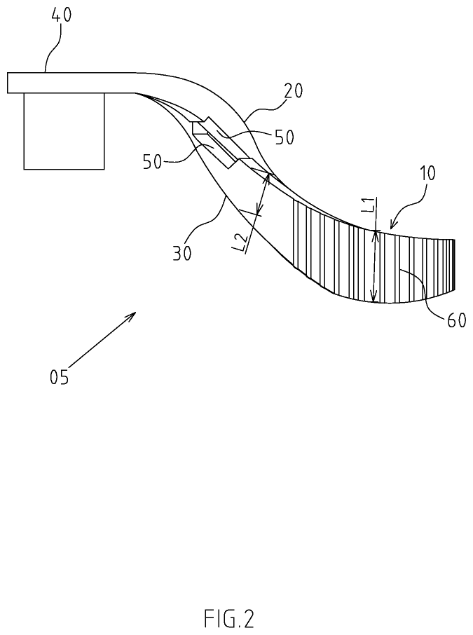

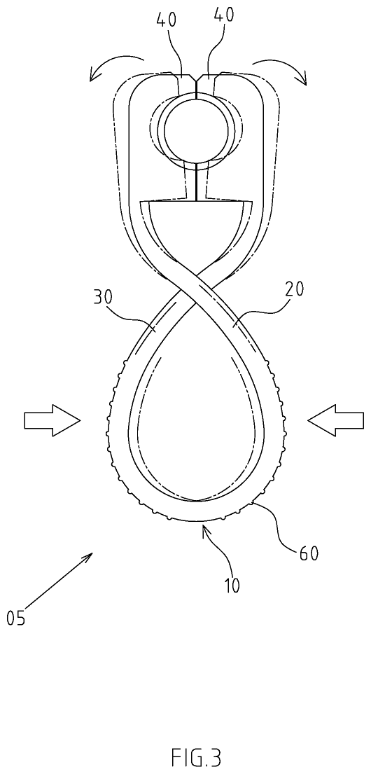

With reference to FIGS. 1 to 3 for a hose remover 05 of the present invention, the hose remover 05 comprises:

an arcuate flexible section 10, having a flexibility on both opposite sides of the arcuate flexible section 10 separately, and both flexibilities capable of tying close to each other or being away from each other and restoring original position; the arcuate flexible section 10, wherein the arcuate flexible section 10 has an anti-slip flange 60 in a predetermined type and the anti-slip flange 60 includes but not limited to an arranged rib, a distributed bump, or a combination of the two;

a first extending portion 20, formed and extending from a side of the arcuate flexible section 10;

a second extending portion 30, formed and extending from the other side of the arcuate flexible section 10 which is different from the side of the first extending portion 20;

two hose clamping portions 40, formed at ends of the first and second extending portions 20, 30 respectively, such that the arcuate flexible section 10, the first extending portion 20, the second extending portion 30 and the hose clamping portion 40 are in an integral structure mod;

wherein, the first and second extending portions 20, 30 extend towards different directions to form an up and down intersecting form, and the hose clamping portions 40 normally lean against another hose clamping portion 40, and the arcuate flexible section 10 is pressed to spread the hose clamping portions 40 away from one another or to lean the hose clamping portions 40 against one another.

With reference to FIGS. 1 to 4 for a specific embodiment of the present invention, the first and second extending portions 20, 30 have at least one limiting slot 50 formed at an intersection position, and the limiting slot 50 is substantially a notch. When the first and second extending portions 20, 30 move with respect to each other, the limiting slot 50 is abutted to limit the moving distance between the first and second extending portions 20, 30.

Wherein, the arcuate flexible section 10, the first extending portion 20 and the second extending portion 30 are plates with the height in the longitudinal direction, and the height of the arcuate flexible section 10 (as labeled by the numeral L1) is greater than first and second extending portions 20, 30, so that the flexibility of the height (as labeled by the numeral L2) of the first and second extending portions 20, 30 is greater than that of the arcuate flexible section 10.

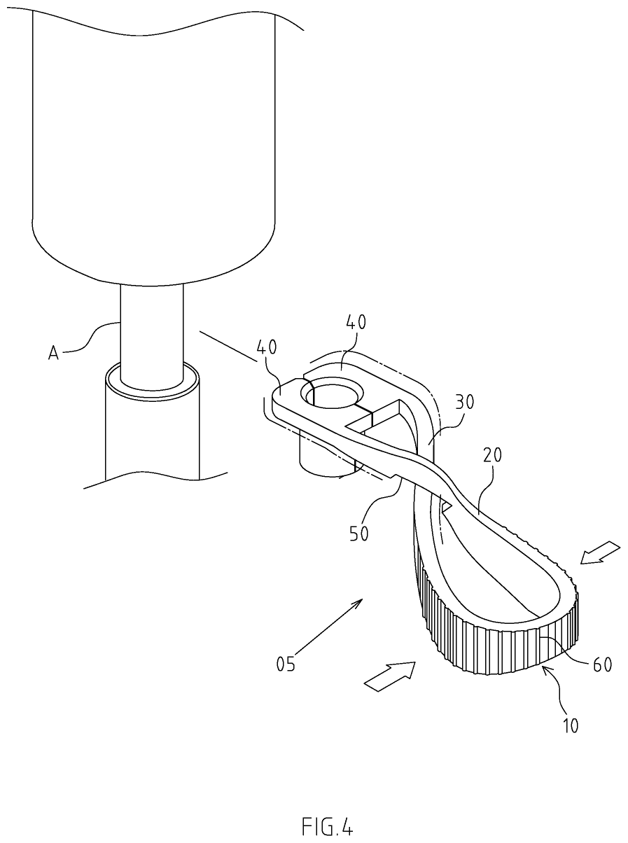

With reference to FIG. 4 for an operation of the present invention, a user simply presses the arcuate flexible section 10 to separate the hose clamping portions 40 into a spread state, and return the hose clamping portions 40 to a predetermined position of the hose A. After the user releases the arcuate flexible section 10, the two hose clamping portions 40 clamp the hose A for the removal of the hose A. Compared with the prior art, the present invention adopts an integral structure to simply and overcome the issue of having too many components, and the flexible positioning restoration of the clamping motion improves the conventional single-piece structure good for one size only and incapable of making adjustment. Obviously, the present invention overcomes the aforementioned two drawbacks and has the advantages of providing an all-in-one function, simplifying the structure, and lowering the manufacturing and assembling costs.

What is claimed is:

1. A hose remover, comprising:
an arcuate flexible section, having a flexibility on both opposite sides of the arcuate flexible section separately, and both flexibilities capable of tying close to each other or being away from each other and restoring original position;
a first extending portion, formed and extending from a side of the arcuate flexible section;
a second extending portion, formed and extending from the other side of the arcuate flexible section which is different from the side of the first extending portion;
two hose clamping portions, formed at ends of the first and second extending portions respectively, such that the arcuate flexible section, the first extending portion, the second extending portion and the hose clamping portion are in an integral structure mode;
wherein, the first and second extending portions extend towards different directions to form an up and down intersecting form, and the hose clamping portions normally lean against each other, and the arcuate flexible section is pressed to spread the hose clamping portions away from one another or to lean the hose clamping portions against one another.

2. The hose remover of claim 1, wherein the first and second extending portions have at least one limiting slot formed at the intersection thereof, and the limiting slot is in form of a notch, and when the first and second extending portions move with respect to each other, the limiting slots are provided for abutment to limit the moving distance between the first and second extending portions.

3. The hose remover of claim 2, wherein the arcuate flexible section, the first extending portion, and the second extending portion is in form of a plate with a height extending in a longitudinal direction, and the arcuate flexible section has a height greater than those of the first and second extending portions.

4. The hose remover of claim 1, wherein the arcuate flexible section has an anti-slip flange in a predetermined type, and the anti-slip flange is in a type selected from an arranged rib or a distributed bump.
